(19) United States
(12) Patent Application Publication
(10) Pub. No.: US 2016/0039076 A1
(43) Pub. Date: Feb. 11, 2016

(54) FLANGE CATCHING, ALIGNING AND CLOSING TOOL

(71) Applicant: OSPREY SUBSEA TECHNICAL SOLUTIONS (OSTS) PTY LTD, Perth BC, Western Australia (AU)

(72) Inventor: Roy VOSS, Ascot (AU)

(21) Appl. No.: 14/763,322

(22) PCT Filed: Jun. 5, 2013
(86) PCT No.: PCT/AU2013/000599

§ 371 Date: Jul. 24, 2015

(30) Foreign Application Priority Data
Jun. 5, 2012 (AU) 2012902352

(51) Int. Cl. B25B 27/16; E21B 17/02; F16L 1/26; F16L 1/10; F16L 1/09

(52) U.S. Cl. CPC B25B 27/16; F16L 1/10; F16L 1/09; F16L 1/26; E21B 17/02

(57) ABSTRACT

A flange catching, aligning and closing tool (10) designed to facilitate the tie-in of spools and other similar mechanical assemblies that utilise a bolted flange for installation, for example, in subsea pipelines. The tool (10) has an elongate support member (12) having a locating pin (14) mounted adjacent one end with its longitudinal axis (16) substantially parallel to a longitudinal axis (18) of the support member (12). A slide assembly (20) is slidably mounted on the support member (12) and has a movable drift pin (22) provided in connection therewith. In use, when the locating pin (14) is located in a bolt hole on a first flange, a second flange can be brought into partial alignment with the first flange by engaging with the support member (12), and the drift pin (22) can be inserted in a matching bolt hole in the second flange to bring the two flanges into full alignment.

### FIELD OF THE INVENTION

The present invention relates to a tool and method for catching, aligning and closing the flanges on a spool or similar mechanical assembly that utilises a bolted flange for installation and relates particularly, though not exclusively, to such a tool and method used for subsea spool tie-ins.

### BACKGROUND TO THE INVENTION

Subsea pipelines and flow-lines are used for the transportation of crude oil and gas from subsea wells, other subsea structures, and off-shore processing facilities, as well as for re-injecting water and gas into subsea reservoirs. Achieving successful tie-in and connection of subsea pipelines and flow-lines is a delicate and important element of subsea oil and gas field development. Typically spools are used to effect the connection between the pipeline and a well head or other subsea structure.

Spools can vary greatly in weight, diameter, length and geometry, from a small 2″×2 m straight spool to a 24″×50 m multi dogleg spool to a 60″ spool of varying lengths. This makes the task of completing a spool tie-in a significant ordeal, taking many hours to complete and often with only one diver working alone at any given time.

The method currently generally employed to install a spool piece between a tie-in point and a newly laid pipeline involves the following steps:
a) Removing the blind flange from the receiving flange and pipeline.
b) Lift bags and safety hold-backs lines are installed.
c) The bags are inflated to lighten and level the spool.
d) Through-hole come-a-longs or lever hoists are installed through the receiving flange boltholes and the coinciding holes in the spools swivel flange, and the gap is closed using the come-a-longs or lever hoists until a suitably small gap exists to install the ring gasket.
e) The bolt holes are rarely concentric so extra through-hole come-along's, podge bars and sledge hammers are employed to rotate the swivel flange so that bolts can be inserted through both flanges. The faces must be near-to-parallel to enable the bolts to go through both flanges as the tolerances are close between the bolt holes and the bolt diameters.
f) All gaps are equalled at the four cardinal points around the flange using the come-a-longs, thus making the faces square or parallel before all bolts can be inserted. This normally requires an array of rigging equipment and anchors to create purchase points for the rigging.
g) Bolt tensioning hydraulic jacks or similar jacks and reaction nuts are installed onto the bolts, and the bolts are then tensioned.
h) The jacks are released and the flange is de-rigged and the task is repeated at the other end of the spool to tie the spool into the pipeline end.

The whole operation is undertaken in-situ (below water), often using a diver to provide manual labour, and frequently with poor visibility. The potential for accidents and injuries is quite high and therefore there is a need to improve the manner in which such subsea spool tie-ins are achieved.

The present invention was developed with a view to providing a flange catching, aligning and closing tool designed to facilitate the quick and efficient tie-in or bolted connection of subsea ridged and flexible spools, pig receivers or launchers and valve assemblies that utilise a bolted flange for installation, whilst reducing the manual labour currently required to accomplish these tie-ins. The tool may enable both ends of a spool to be tied-in at the same time by two divers once the spool has been levelled. It will be understood that the tool and method may also be used above-ground and is not limited to subsea applications.

References to prior art documents in this specification are provided for illustrative purposes only and are not to be taken as an admission that such prior art is part of the common general knowledge in Australia or elsewhere.

### SUMMARY OF THE INVENTION

According to one aspect of the present invention there is provided a flange catching, aligning and closing tool designed to facilitate the tie-in of spools and other similar mechanical assemblies that utilise a bolted flange connection for installation, the tool comprising:

an elongate support member;
a locating pin mounted adjacent one end of the support member with its longitudinal axis substantially parallel to a longitudinal axis of the support member; and,
a slide assembly slidably mounted on the support member and having a movable drift pin provided in connection therewith wherein, in use, when the locating pin is located in a bolt hole on a first flange a second flange can be brought into partial alignment with the first flange by engaging with the support member, and the drift pin can be inserted in a matching bolt hole in the second flange to bring the two flanges into full alignment as the tool is actuated.

Preferably the drift pin is movably mounted in a drift pin alignment part fixed to the slide assembly. Preferably the drift pin is mounted with its longitudinal axis substantially parallel to a longitudinal axis of the support member. Preferably the drift pin has a tapered end so that it can be inserted into the matching bolt hole even if it is slightly misaligned. Preferably the locating pin is fixed adjacent one end of the support member on a first bracing bracket. Advantageously the distance between the longitudinal axis of both the drift pin and the locating pin and an outer surface of the support member is substantially equal to the distance between the central axes of the bolt holes on the first and second flanges and the outer circumference of the flanges.

Preferably the drift pin alignment part is mounted in first and second bracing brackets fixed to the slide assembly. In one embodiment the drift pin is removably mounted in the drift alignment part. In another embodiment a hydraulic actuator is provided for moving the drift pin into the matching bolt hole in the second flange. Preferably the locating pin is fixed adjacent one end of the support member on first and second bracing brackets.

Preferably the tool further comprises an actuator mechanically coupled to the support member for driving the slide assembly along the support member wherein, in use, the slide member can be pushed or pulled towards the locating pin to move the first and second flanges closer to each other. In one embodiment the actuator comprises a motor driven screw-thread actuator. In another embodiment the actuator comprises a hydraulic cylinder.

Preferably the elongate support member comprises a hollow cylinder and the slide assembly is slidably mounted on an outer surface of the cylinder. Preferably sliding movement of the slide assembly is controlled by a guide slot provided in a wall of the cylinder. Typically the guide slot extends longitudinally of the cylinder and is substantially linear. Advantageously the guide slot has an enlarged portion at one end to permit a degree of lateral movement of the slide assembly wherein, in use, the drift pin can be more easily inserted into a matching bolt hole on the second flange.

According to another aspect of the present invention there is provided a method of catching, aligning and closing a flange to facilitate the tie-in of spools and other similar mechanical assemblies that utilise a bolted flange connection for installation, the method comprising the steps of:

providing a tool having an elongate support member;
inserting a locating pin in a bolt hole on the first flange, the locating pin being mounted adjacent one end of the support member with its longitudinal axis substantially parallel to a longitudinal axis of the support member;
bringing a second flange into partial alignment with the first flange by bringing it into engagement with the support member which acts as a cantilever; and,
inserting a movable drift pin in a matching bolt hole in the second flange, the drift pin being provided in connection with a slide assembly slidably mounted on the support member wherein, in use, the two flanges can be brought into full alignment when the tool is actuated.

Preferably the step of providing a tool comprises providing two tools, and the step of inserting a locating pin comprises inserting the respective locating pins on both tools in separate bolt holes on the first flange, wherein the step of bringing the second flange into partial alignment with the first flange comprises engaging the second flange with the respective support members of both tools.

Preferably the step of inserting the locating pin comprises inserting the locating pin of each tool in the respective bolt holes at approximately the 5 o'clock and 7 o'clock positions on the first flange. Typically the step of bringing the second flange into partial alignment comprises lowering the second flange until it comes to rest on the cantilevers formed by the respective support members of the two tools.

Preferably the step of inserting a movable drift pin in a matching bolt hole in the second flange, involves driving the drift pins with a hammer if necessary whereby, in use, the second flange will rotate so as to allow the drift pins to pass through the respective bolt holes to bring the two flanges further into alignment. Alternatively the drift pin can be driven by a hydraulic actuator into the matching bolt hole. Typically the method further comprises the step of engaging an actuator provided in connection with each tool so that the flange faces are pulled/pushed closer to each other.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the tool and method for catching, aligning and closing flanges, given by way of example only, with reference to the accompanying drawings, in which:

FIG. 1 is a side elevation of a first embodiment of a tool for catching, aligning and closing flanges according to the present invention;

FIG. 2 is a top plan view of the tool of FIG. 1;

FIG. 3 illustrates how the tool of FIG. 1 can typically be used for catching, aligning and closing a first flange on a spool and a second flange on a pipe line;

FIGS. 4 (a) and (b) illustrate how the first and second flanges are preferably caught, aligned and closed using two of the tools;

FIG. 5 is a side elevation of the tool of FIG. 1 with a first kind of actuator provided in connection therewith;

FIG. 6 is a partial cutaway view of the tool of FIG. 5;

FIGS. 7 (a) to (f) illustrate the tool of FIG. 1 with a second kind of actuator provided in connection therewith in a pull configuration;

FIG. 8 is a partial cutaway view of the tool of FIG. 7;

FIGS. 9 (a) to (e) illustrate a second embodiment of a tool for catching, aligning and closing flanges according to the present invention; and,

FIG. 10 is a partial cutaway view of the tool of FIG. 9.

### DETAILED DESCRIPTION OF PREFERRED EMBODIMENTS

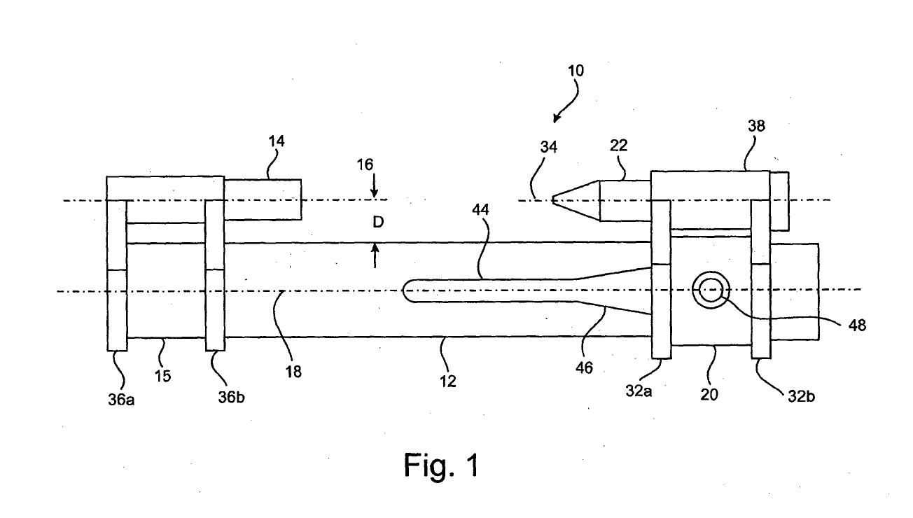

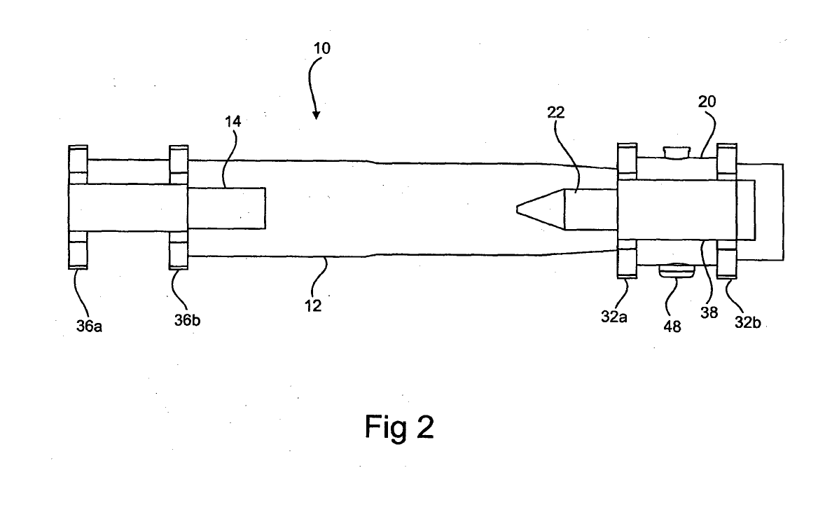

A first embodiment of a tool 10 for catching, aligning and closing flanges in accordance with the invention, as illustrated in FIGS. 1 to 4, comprises an elongate support member 12 with a locating pin 14 mounted adjacent a first end 15 of the support member 12. The locating pin 14 is mounted with its longitudinal axis 16 substantially parallel to a longitudinal axis 18 of the support member 12.

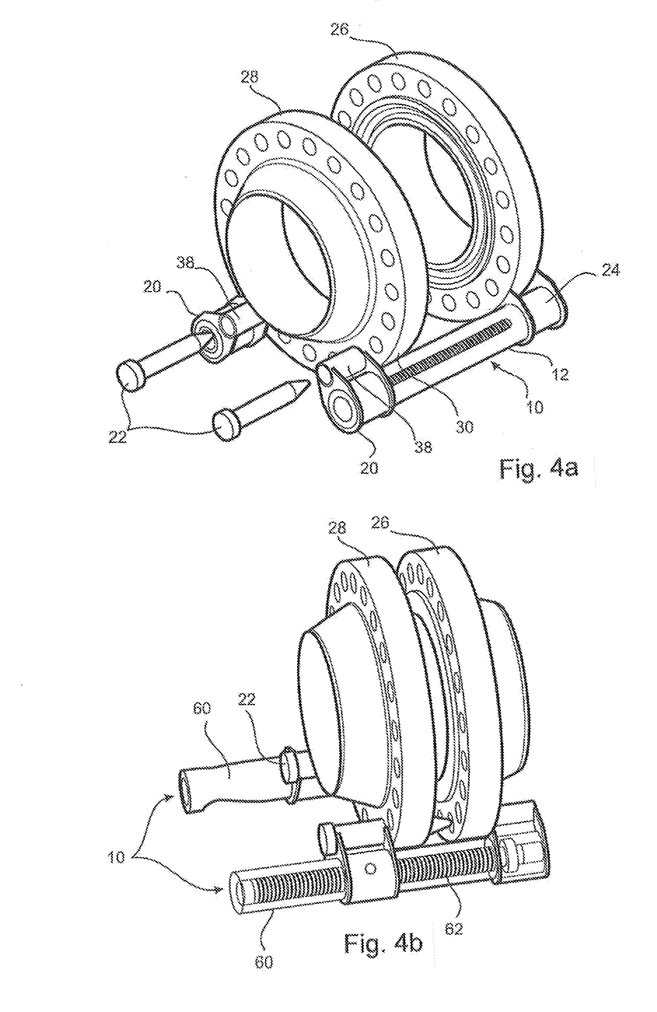

A slide assembly 20 is slidably mounted on the support member 12 and has a movable podger bar or drift pin 22 provided in connection therewith. In use, when the locating pin 14 is located in a bolt hole 24 on a first flange 26 (see FIG. 4), a second flange 28 can be brought into partial alignment with the first flange 26 by resting on the support member 12. The drift pin 22 can then be inserted in a matching bolt hole 30 in the second flange 28 to bring the two flanges into full alignment. A preferred method of catching, aligning and closing flanges in accordance with the invention will be described in more detail below.

Preferably the drift pin 22 is removably mounted in drift pin alignment part 38 which is fixed to the slide assembly 20 by first and second bracing brackets 32a and 32b. Like the locating min 14, the drift pin 22 is also mounted with its longitudinal axis 34 substantially parallel to the longitudinal axis 18 of the support member 12. The locating pin 14 is fixed adjacent the first end 15 of the support member 12 on first and second bracing brackets 36a and 36b. Advantageously the distance ‘D’ (see FIG. 1) between the longitudinal axes of both the drift pin 22 and the locating pin 14 and an outer surface of the support member 12 is substantially equal to the distance between the central axes of the bolt holes 24 and 30 on the first and second flanges 26 and 28 respectively and the outer circumference of the flanges.

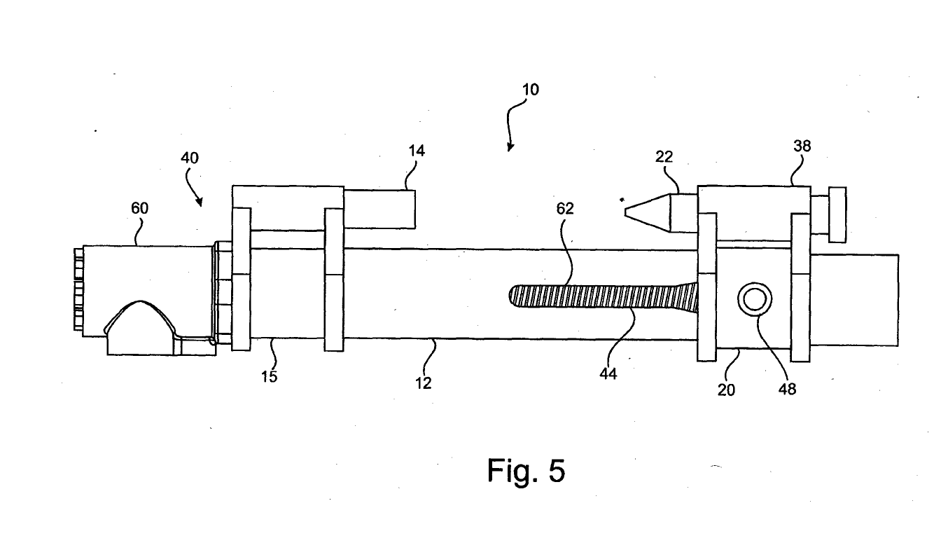

Preferably the tool 10 further comprises an actuator 40 mechanically coupled to the support member 12 for driving the slide assembly 20 along the support member. In use, the slide member 20 (with the drift pin 22) can be pushed or pulled by the actuator 40 towards the locating pin 14 to move the first and second flanges 26 and 28 closer to each other. In one embodiment the actuator 40 comprises a motor driven screw-thread actuator. In another embodiment the actuator 40 comprises a hydraulic cylinder. These different kinds of actuator arrangements will be described in more detail below with reference to FIGS. 5 to 10.

In the illustrated embodiment, the elongate support member comprises a hollow cylinder 12, and the slide assembly 20 is slidably mounted on an outer surface of the cylinder 12. Preferably sliding movement of the slide assembly 20 is controlled by a guide slot 44 provided in a wall of the cylinder 12. Typically the guide slot 44 extends longitudinally of the cylinder 12 and is substantially linear. Advantageously the guide slot 44 has an enlarged portion 46 at one end to permit a degree of lateral movement of the slide assembly 20 in this region.

A rotational alignment guide pin 48 is provided on the slide assembly 20 so as to be slidably received in the guide slot 44. Guide pin 48 has on outer diameter slightly smaller than the width of the guide slot 44 in the linear portion of the guide slot, so that in this region practically no lateral movement of the slide assembly 20 is possible. When the slide assembly 20 is in this region the longitudinal axes 16 and 34 of the locating pin 14 and drift pin 22 respectively are substantially aligned. However in the enlarged portion 46 of the guide slot 44, the guide pin 48 permits about 15° of lateral movement in either direction so that, in use, the drift pin 22 can be more easily inserted into a matching bolt hole 30 on the second flange 28 even when the bolt holes in the respective flanges are not aligned. For this purpose the drift pin 22 preferably has a tapered end so that it can be inserted into the matching bolt hole 30 even if it is misaligned.

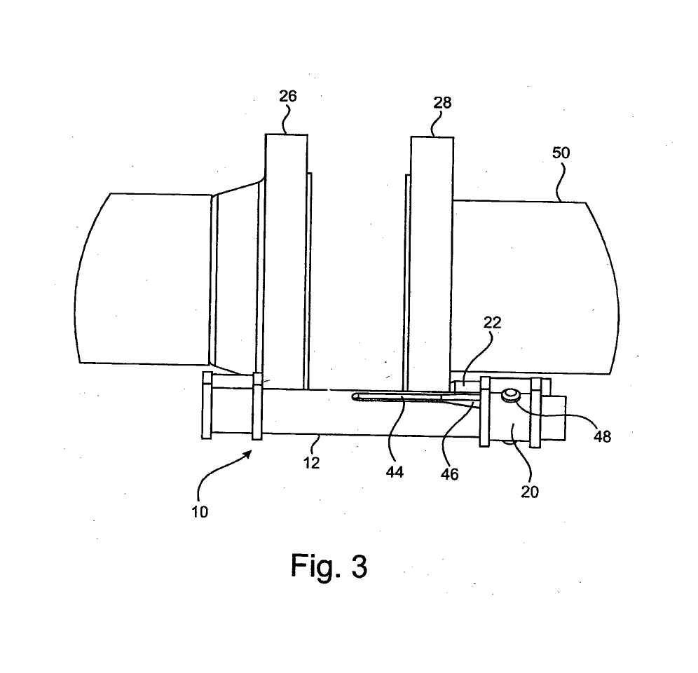

A preferred method of catching, aligning and closing a flange, to facilitate the tie-in of a spool 50, will now be described with reference to FIGS. 3 and 4. Clearly a similar method may be employed with other similar mechanical assemblies that utilise a bolted flange for installation. At least one of the tools 10 is provided, having an elongate support member 12. Preferably two of the tools 10 are provided and respectively installed at approximately the 5 o'clock and 7 o'clock positions on the first or receiving flange 26 (the flange to which the spool 50 is to be tied-in to). Each tool 10 is installed by inserting its locating pin 14 in the respective bolt holes 24 at approximately the 5 o'clock and 7 o'clock positions on the receiving flange 26.

The support members 12 of both tools 10 seat against the outside diameter of the flange 26, projecting forwards of the flange face and provide a cantilever to receive the second or closing flange 28 of the spool 50. The closing flange 28 is then lowered until it comes to rest on the cantilevers formed by the respective support members 12 of the two tools. The closing flange 28 is thus brought into partial/concentric alignment with the receiving flange 26 by catching it on the support members 12 between the receiving flange face and the closest face of the slide assembly 20. Because of the predefined distance ‘D’ between the longitudinal axes 16 of the locating pins 14 and the outer surface of the respective support members 12, this will place the bolt holes 24 of the receiving flange 26 on the same pitch diameter, but not necessarily concentric, with the bolt holes 30 of the spool flange 28. In fact it is unlikely that the bolt holes would be concentric at this stage but would expected to be up to a full bolt hole out of alignment

The spool 50 normally has a swivel flange 28, so that when the podger bars (drift pins 22) pass through the drift pin alignment part 38 of the slide assembly 20 and are inserted in the matching bolt holes 30 of the receiving flange 26, (by being driven with a hammer if necessary) the swivel flange 28 will rotate so as to allow the drift pins 22 to pass through the bolt holes 30. Thus the two flanges can be brought further into alignment.

The enlarged portion 46 of the guide slot 44, in which the guide pin 48 of the slide assembly 20 travels, allows the slide assembly 20 to rotate laterally to a degree. This rotational movement facilitates the driving into place of the drift pins 22, in the event that the swivel flange bolt holes 30 are not concentric with the bolt holes of the receiving flange 26.

The actuator 40 is then engaged and the flange faces are pulled/pushed closer to each other (the spool flange 28 moves closer as the receiving flange 26 is fixed). As the slide assembly 20 drives the spool flange face closer to the receiving flange face, the guide pin 48 moves along the guide slot 44 until it enters the narrow region of the guide slot. Because the drift pins 22 have been inserted in the bolt holes 30 of the receiving flange 26, this action causes the spool flange 28 to swivel, (if there is any remaining misalignment) so that the bolt holes in both flanges become fully aligned. At this point the outside diameters of both flanges are concentric; and each of the bolt holes 24 in the receiving flange 26 are also concentric with the matching bolt holes 30 of the spool flange 28.

As the flanges are drawn closer together a gasket is inserted between the faces, (gasket insertion is not effected with this tool) then the tool closes the final gap, so that there is an equal gap between the flange faces of both flanges and at all cardinal clock positions. (3, 6, 9, & 12 o'clock) This finishes the job of the tool 10 as such, but for completeness the following steps would then be carried out.

All bolts would be inserted in the remaining bolt holes not occupied by the two tools 10 (all but two bolt holes). The nuts would be run onto the bolts and hand-tightened to prevent the gap from opening as the tools 10 are removed. The tools 10 would then be removed and the final two bolts inserted in their stead. Hydraulic tensioning jacks would then be installed on each bolt and the bolts tensioned according to standard procedure. Finally all equipment would be removed from the flanges and bolts.

In a modified form of the method of catching, aligning and closing a flange, two of the tools 10 could be installed on the swivel flange 28 on spool 50 prior to being lowered into the water. However in this modified method the installation would effectively be reversed, i.e. each tool 10 is installed by inserting its locating pin 14 in the respective bolt holes 24 at approximately the 1 o'clock and 11 o'clock positions on the swivel flange 28. In this configuration, as the swivel flange 28 on spool 50 is lowered into position the support members 12 of both tools land on the OD at the top of the receiving flange 26. The procedure from then on would be substantially the same as that described above except the orientation is reversed, i.e. the drift pins 22 would be driven into the bolt holes 24 on the receiving flange 26. The swivel flange will still be on the spool side, so any rotational alignment would still be achieved by rotation of the spool swivel flange 28.

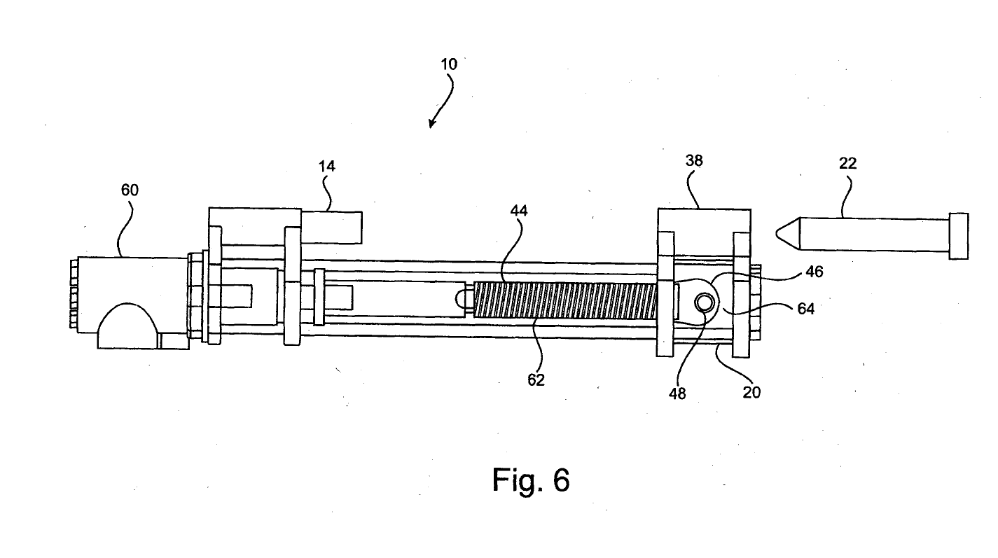

FIGS. 5 and 6 illustrate the tool 10 with a first kind of actuator 40 in the form of a hydraulic motor 60 with a screw-thread/worm drive 62 (also shown in FIG. 4 (b)). A hydraulic motor 60 is mounted on the first end 15 of cylindrical support member 12, and a worm drive 62 is provided through the centre of the cylinder 12. The guide pin 48, on the slide assembly 20, engages with a nut 64 (see FIG. 6) on the worm drive 62 so as to transfer the forces to the slide assembly 20 for linear motion. The guide pin 48 is in two parts which are embedded 180° apart in opposite sides of the nut 64 and aligned with the guide slot 44. The nut 64 also acts as a swivel to allow a degree of rotational movement of the slide assembly 20 when guide pin 48 is in the enlarged portion 46 of the guide slot 44. With this arrangement, the hydraulic motor pulls the flanges together to the point where the gasket would be inserted, and then continues until the gasket is captured between the flange faces. Then the tensioning bolts would be inserted and the tool 10 removed.

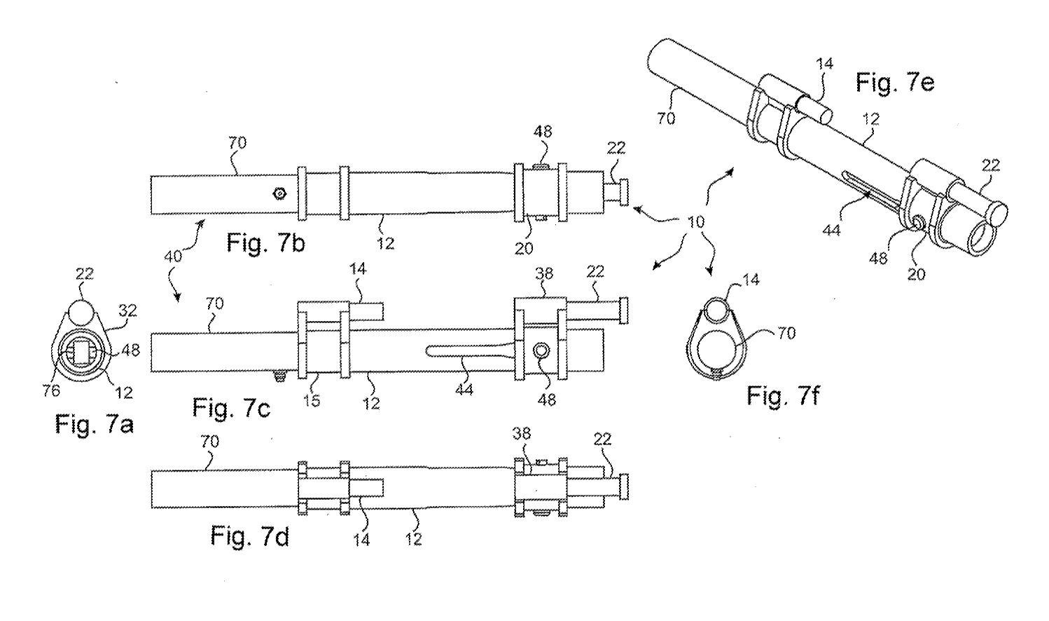

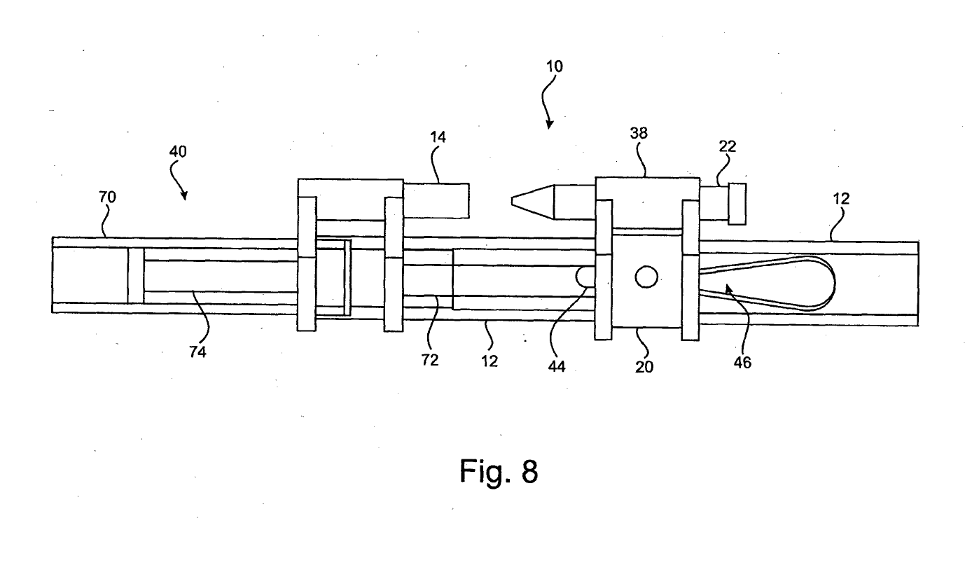

FIGS. 7 and 8 illustrate the tool 10 with a second kind of actuator 40 in the form of a hydraulic ram 70 with a piston 74 in a pull configuration. The hydraulic ram 70 is mounted on the first end 15 of cylindrical support member 12, and a shaft 72 of piston 74 extends through the centre of the cylinder 12. The guide pin 48, on the slide assembly 20, also passes through a swivel 76 (see FIG. 7(a)) on the end of the piston shaft 72 so as to transfer the forces to the slide assembly 20 for linear motion. With this arrangement, the hydraulic ram 70 pulls the flanges together to such a point where the gasket would be inserted, and then continued until the gasket is captured between the flange faces. Then the tensioning bolts would be inserted and the tool 10 removed.

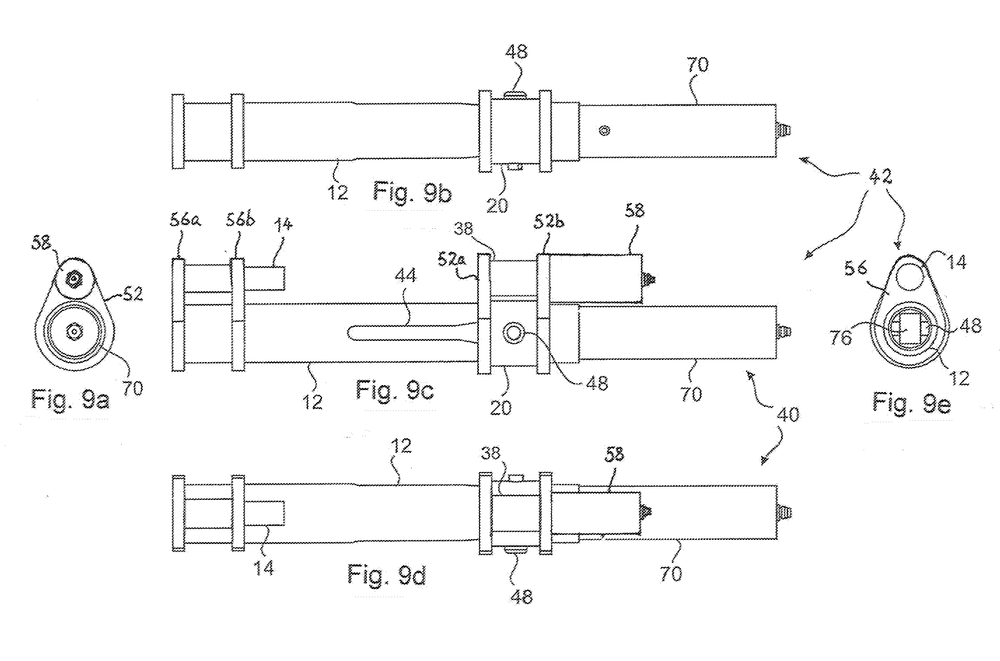

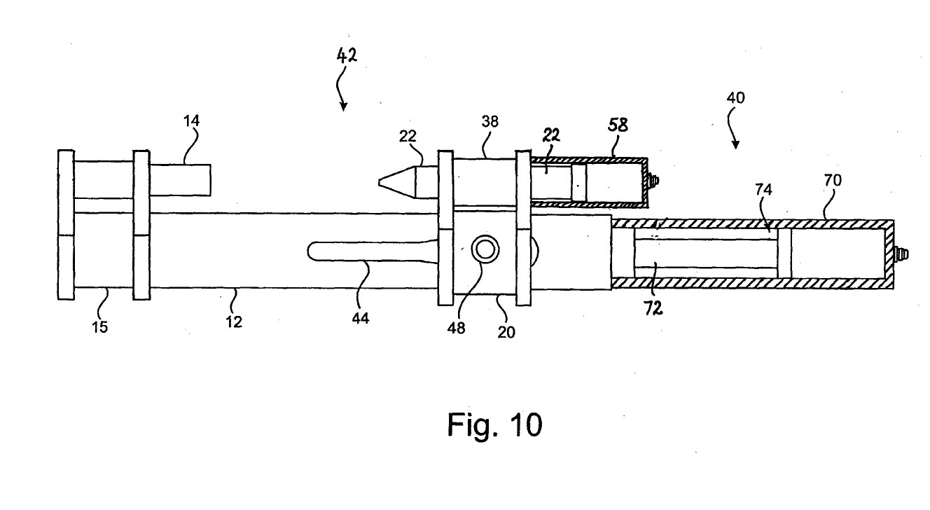

FIGS. 9 and 10 illustrate a second embodiment of a tool 42 for catching, aligning and closing flanges according to the present invention. The tool 42 is similar to the tool 10 of FIGS. 7 and 8 and therefore the similar parts are identified with same reference numerals and will not be described again in detail. The tool 42 is also provided with a second kind of actuator 40 in the form of a hydraulic ram 70 with a piston 74, however in this case the actuator 40 is configured in a push configuration. The actuator 40 is shown in section view in FIG. 10. The hydraulic ram 70 is mounted on the opposite end of cylindrical support member 12, and a shaft 72 of piston 74 extends into the cylinder 12 to the slide assembly 20. The guide pin 48, on the slide assembly 20, passes through a swivel 76 (see FIG. 9(e)) on the end of the piston shaft 72 so as to transfer the forces to the slide assembly 20 for linear motion. With this arrangement, the hydraulic ram 70 can be used to push the flanges together to such a point where the gasket would be inserted, and then continued until the gasket is captured between the flange faces. Then the tensioning bolts would be inserted and the tool 42 removed.

The tool 42 also incorporates a few other modifications compared to the first embodiment of the tool 10. Firstly, the drift pin 22 is movably mounted in drift pin alignment part 38 which is fixed to the slide assembly 20 by first and second bracing brackets 52a and 52b. Unlike the bracing brackets 32 of the first embodiment, the bracing brackets 52 extend all the way around the circumference of the alignment part 38, as can be seen most clearly in FIG. 9(a). Likewise, the locating pin 14 is fixed adjacent the first end 15 of the support member 12 on first and second bracing brackets 56a and 56b.

Unlike the bracing brackets 36 of the first embodiment, the bracing brackets 56 extend all the way around the circumference of the locating pin 14, as can be seen most clearly in FIG. 9(e). The bracing brackets 52 and 56 provide a more secure mounting for the drift pin alignment part 38 and locating pin 14 respectively.

Secondly, the drift pin 22 of the tool 42 is provided with a hydraulic actuator 58 for driving the drift pin into a matching bolt hole 30 in the second flange 28 to bring the two flanges into full alignment. The drift pin 22 is not visible in FIG. 9 as it is shown fully retracted within the hydraulic actuator 58; however in FIG. 10 the hydraulic actuator 58 is shown in section view. The hydraulic actuator 58 is provided integral with the drift pin alignment part 38, and is supported by the bracing brackets 52 with its longitudinal axis substantially parallel to the longitudinal axis of the support member 12. The hydraulic actuator 58 removes the need to manually insert the drift pin 22 into the matching bolt hole 30. This may facilitate diver-less spool tie-ins in which Remote Operated Vehicles (ROVs) are utilised instead of divers. This would allow the tool to be used at much greater depths or in areas where the operator of the field chose to go diver-less.

Now that preferred embodiments of the tool and method for catching, aligning and closing flanges have been described in detail, it will be apparent that they provides a number of advantages over the prior art, including the following:
(i) By combining the functions of catching, aligning and closing the flanges in a single tool the method of connecting the flanges is greatly simplified.
(ii) The tool facilitates alignment of both flange outside diameters (OD), the bolthole pitch circle, the gasket groove and the individual bolt holes, making them all concentric whilst the flange faces are being drawn together and bolts can be inserted prior to bolt tensioning.
(iii) The tool facilitates the quick and efficient tie-in of subsea ridged and flexible spools, pig receivers or launchers and valve assemblies that utilise a bolted flange for installation whilst reducing manual labour and physical effort currently required to accomplish these tie-ins.
(iv) The tool also enables both ends of a spool to be tied-in at the same time by two divers once the spool has been levelled.
(v) By the use of this invention in either configuration the necessity to use lift bags would be significantly reduced. This is a safer and more controlled method of spool placement. Lift bags can pose a substantial risk to divers, the surrounding oil and gas infrastructure, and in extreme cases the vessel itself if there is an uncontrolled assent of the lift bag and attached spool to the surface. Work methods that reduce utilisation of lift bags can only be seen as a step forward for the environment and personnel safety in the oil and gas industry.

It will be readily apparent to persons skilled in the relevant arts that various modifications and improvements may be made to the foregoing embodiments, in addition to those already described, without departing from the basic inventive concepts of the present invention. For example, the tool may be configured to be also capable of splitting/opening the flanges (i.e. work in the opposite direction to that described above). The tool may also be configured so as to be capable of supporting a gasket concentric with the gasket groove whilst closing the spool the last centimetres just prior to entrapment of the gasket in the groove. Therefore, it will be appreciated that the scope of the invention is not limited to the specific embodiments described.

1. A flange catching, aligning and closing tool designed to facilitate the tie-in of spools and other similar mechanical assemblies that utilise a bolted flange connection for installation, the tool comprising:
an elongate support member;
a locating pin mounted adjacent one end of the support member with its longitudinal axis substantially parallel to a longitudinal axis of the support member; and,
a slide assembly slidably mounted on the support member and having a movable drift pin provided in connection therewith wherein, in use, when the locating pin is located in a bolt hole on a first flange a second flange can be brought into partial alignment with the first flange by engaging with the support member, and the drift pin can be inserted in a matching bolt hole in the second flange to bring the two flanges into full alignment as the tool is actuated.

2. A flange catching, aligning and closing tool as defined in claim 1, wherein the drift pin is movably mounted in a drift pin alignment part fixed to the slide assembly.

3. A flange catching, aligning and closing tool as defined in claim 1, wherein the drift pin is mounted with its longitudinal axis substantially parallel to a longitudinal axis of the support member.

4. A flange catching, aligning and closing tool as defined in claim 3, wherein the drift pin has a tapered end so that it can be inserted into the matching bolt hole even if it is slightly misaligned.

5. A flange catching, aligning and closing tool as defined in claim 1, wherein the locating pin is fixed adjacent one end of the support member on a first bracing bracket.

6. A flange catching, aligning and closing tool as defined in claim 1, wherein the distance between the longitudinal axis of both the drift pin and the locating pin and an outer surface of the support member is substantially equal to the distance between the central axes of the bolt holes on the first and second flanges and the outer circumference of the flanges.

7. A flange catching, aligning and closing tool as defined in claim 2, wherein the drift pin alignment part is mounted in first and second bracing brackets fixed to the slide assembly.

8. A flange catching, aligning and closing tool as defined in claim 7, wherein the drift pin is removably mounted in the drift alignment part.

9. A flange catching, aligning and closing tool as defined in claim 7, wherein a hydraulic actuator is provided for moving the drift pin into the matching bolt hole in the second flange.

10. A flange catching, aligning and closing tool as defined in claim 5, wherein the locating pin is fixed adjacent one end of the support member on first and second bracing brackets.

11. A flange catching, aligning and closing tool as defined in claim 1, further comprising an actuator mechanically coupled to the support member for driving the slide assembly along the support member wherein, in use, the slide member can be pushed or pulled towards the locating pin to move the first and second flanges closer to each other.

12. A flange catching, aligning and closing tool as defined in claim 11, wherein the actuator comprises a motor driven screw-thread actuator.

13. A flange catching, aligning and closing tool as defined in claim 11, wherein the actuator comprises a hydraulic cylinder.

14. A flange catching, aligning and closing tool as defined in claim 1, wherein the elongate support member comprises a hollow cylinder and the slide assembly is slidably mounted on an outer surface of the cylinder.

15. A flange catching, aligning and closing tool as defined in claim 14, wherein sliding movement of the slide assembly is controlled by a guide slot provided in a wall of the cylinder.

16. A flange catching, aligning and closing tool as defined in claim 15, wherein the guide slot extends longitudinally of the cylinder and is substantially linear.

17. A flange catching, aligning and closing tool as defined in claim 16, wherein the guide slot has an enlarged portion at one end to permit a degree of lateral movement of the slide assembly wherein, in use, the drift pin can be more easily inserted into a matching bolt hole on the second flange.

18. A method of catching, aligning and closing a flange to facilitate the tie-in of spools and other similar mechanical assemblies that utilise a bolted flange connection for installation, the method comprising the steps of:
providing a tool having an elongate support member;
inserting a locating pin in a bolt hole on the first flange, the locating pin being mounted adjacent one end of the support member with its longitudinal axis substantially parallel to a longitudinal axis of the support member;
bringing a second flange into partial alignment with the first flange by bringing it into engagement with the support member which acts as a cantilever; and,
inserting a movable drift pin in a matching bolt hole in the second flange, the drift pin being provided in connection with a slide assembly slidably mounted on the support member wherein, in use, the two flanges can be brought into full alignment when the tool is actuated.

19. A method of catching, aligning and closing a flange as defined in claim 18, wherein the step of providing a tool comprises providing two tools, and the step of inserting a locating pin comprises inserting the respective locating pins on both tools in separate bolt holes on the first flange, wherein the step of bringing the second flange into partial alignment with the first flange comprises engaging the second flange with the respective support members of both tools.

20. A method of catching, aligning and closing a flange as defined in claim 19, wherein the step of inserting the locating pin comprises inserting the locating pin of each tool in the respective bolt holes at approximately the 5 o'clock and 7 o'clock positions on the first flange.

21. A method of catching, aligning and closing a flange as defined in claim 19, wherein the step of bringing the second flange into partial alignment comprises lowering the second flange until it comes to rest on the cantilevers formed by the respective support members of the two tools.

22. A method of catching, aligning and closing a flange as defined in claim 21, wherein the step of inserting a movable drift pin in a matching bolt hole in the second flange, involves driving the drift pins with a hammer if necessary whereby, in use, the second flange will rotate so as to allow the drift pins to pass through the respective bolt holes to bring the two flanges further into alignment.

23. A method of catching, aligning and closing a flange as defined in claim 21, wherein the step of inserting a movable drift pin in a matching bolt hole in the second flange, involves driving the drift pins with a hydraulic actuator whereby, in use, the second flange will rotate so as to allow the drift pins to pass through the respective bolt holes to bring the two flanges further into alignment.

24. A method of catching, aligning and closing a flange as defined in claim 1, further comprises the step of engaging an actuator provided in connection with each tool so that the flange faces are pulled/pushed closer to each other.
